(19) United States
(12) Patent Application Publication
(10) Pub. No.: US 2013/0201226 A1
(43) Pub. Date: Aug. 8, 2013

(54) Liquid Crystal Display Driving Method and Display Device Using the Same

(71) Applicant: NOVATEK Microelectronics Corp., Hsin-Chu (TW)

(72) Inventor: Tse-Hung Wu, New Taipei City (TW)

(73) Assignee: NOVATEK MICROELECTRONICS CORP., Hsin-Chu (TW)

(21) Appl. No.: 13/751,146

(22) Filed: Jan. 28, 2013

(30) Foreign Application Priority Data
Feb. 2, 2012 (TW) 101103347

(51) Int. Cl. G09G 5/10

(52) U.S. Cl. CPC G09G 5/10
USPC 345/690

(57) ABSTRACT

A driving method for a display device includes receiving a first image data corresponding to a display of the display device and composed of a plurality of frames; obtaining a first frame and a second frame neighboring to the first frame from the plurality of frames; calculating a plurality of sub-frames according to the first frame and the second frame; adjusting a brightness of at least one sub-frame of the plurality of sub-frames, to have an average brightness of the plurality of sub-frames be lower than an average brightness of the plurality of frames; sequentially inserting the plurality of sub-frames between the first frame and the second frame, to obtain a second image data; and driving the display device according to the second image data.

### BACKGROUND OF THE INVENTION

1. Field of the Invention

The present invention relates to a liquid crystal display driving method and related display device, and more particularly, to a liquid crystal display driving method and related display device for inserting sub-frames with different brightness combinations to enhance dynamic display effect of the liquid crystal display device with low power consumption.

2. Description of the Prior Art

In general, when driving a liquid crystal display (LCD) device, a frame rate can be increased for improving image quality of dynamic frames and reducing the phenomenon of motion blur. However, power consumption of the LCD device may be increased due to the increased frame rate. Therefore, the prior art has provided a method of black frame insertion to insert black frames into the dynamic frames, so as to reduce power consumption. However, inserting the black frames can cause decrease of display brightness.

Please refer to FIG. 1A-FIG. 1C, which are schematic diagrams of image data 100 of a conventional display device. As shown in FIG. 1A, the image data 100 is composed of a plurality of frames F1-Fn. A frame rate of the image data 100 is 60 Hz, and can be increased to enhance dynamic display effect. First of all, as shown in FIG. 1B, three sub-frames (e.g. Fk_1, Fk_2, Fk_3) derived from calculation are inserted between adjacent frames (e.g. Fk, F(k+1)) in FIG. 1A, to obtain an image data 102 with a frame rate 240 Hz. However, such a driving method consumes more than four times power the driving method in FIG. 1A requires. Next, as shown in FIG. 1C, three black frames are inserted between the adjacent frames in FIG. 1A, to obtain an image data 104 with a frame rate 240 Hz, which reaches a brightness approximate to a quarter of the brightness the driving method in FIG. 1A reaches.

Therefore, it is a common goal in the industry to improve the conventional driving method of the display device, to solve the issues of brightness degradation and power consumption due to frame insertion.

### SUMMARY OF THE INVENTION

It is therefore an objective of the present invention to provide a liquid crystal display driving method and related display device, for inserting sub-frames with different brightness combinations into an image data of the display device, to improve dynamic display effect and power consumption of the display device.

The present invention discloses a driving method for a display device. The driving method includes receiving a first image data corresponding to a display of the display device and composed of a plurality of frames; obtaining a first frame and a second frame neighboring to the first frame from the plurality of frames; calculating a plurality of sub-frames according to the first frame and the second frame; adjusting a brightness of at least one sub-frame of the plurality of sub-frames, to have an average brightness of the plurality of sub-frames be lower than an average brightness of the plurality of frames; sequentially inserting the plurality of sub-frames between the first frame and the second frame, to obtain a second image data; and driving the display device according to the second image data.

The present invention further discloses a driving device for a display device. The driving device includes a receiving unit, for receiving a first image data corresponding to a display of the display device and composed of a plurality of frames; a calculating unit, for obtaining a first frame and a second frame neighboring to the first frame from the plurality of frames, and calculating a plurality of sub-frames according to the first frame and the second frame; an adjusting unit, for adjusting a brightness of at least one sub-frame of the plurality of sub-frames, to have an average brightness of the plurality of sub-frames be lower than an average brightness of the plurality of frames, and sequentially inserting the plurality of sub-frames between the first frame and the second frame, to obtain a second image data; and a driving unit, for driving the display device according to the second image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A-FIG. 1C are schematic diagrams of image data of a conventional display device.

FIG. 2 is a schematic diagram of a driving process according to an embodiment of the present invention.

FIG. 3A-FIG. 3F are schematic diagrams of different driving methods according to an embodiment of the present invention.

FIG. 4A-FIG. 4F are schematic diagrams of different driving methods according to an embodiment of the present invention.

FIG. 5A-FIG. 5D are schematic diagrams of different driving methods according to an embodiment of the present invention.

FIG. 6 is a schematic diagram of a display device according to an embodiment of the present invention.

### DETAILED DESCRIPTION

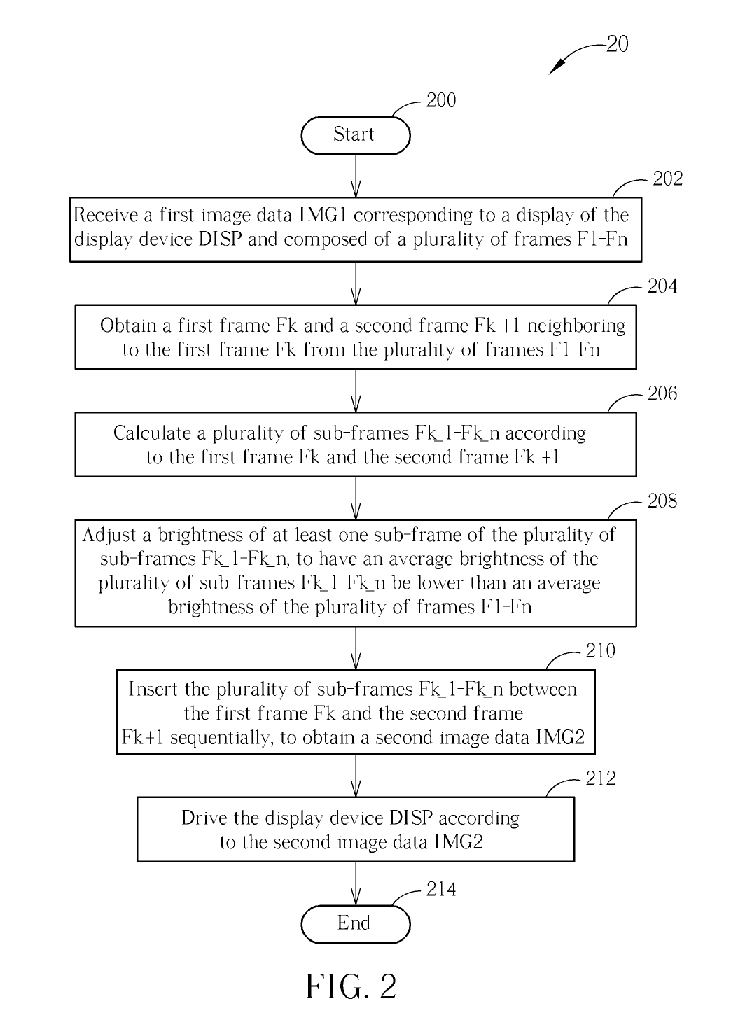

Please refer to FIG. 2, which is a schematic diagram of a display driving process 20 according to an embodiment of the present invention. The display driving process 20 is applied to a display device DISP, and includes the following steps:

Step 200: Start.

Step 202: Receive a first image data IMG1 corresponding to a display of the display device DISP and composed of a plurality of frames F1-Fn.

Step 204: Obtain a first frame Fk and a second frame Fk+1 neighboring to the first frame Fk from the plurality of frames F1-Fn.

Step 206: Calculate a plurality of sub-frames Fk_1-Fk_n according to the first frame Fk and the second frame Fk+1.

Step 208: Adjust a brightness of at least one sub-frame of the plurality of sub-frames Fk_1-Fk_n, to have an average brightness of the plurality of sub-frames Fk_1-Fk_n be lower than an average brightness of the plurality of frames F1-Fn.

Step 210: Insert the plurality of sub-frames Fk_1-Fk_n between the first frame Fk and the second frame Fk+1 sequentially, to obtain a second image data IMG2.

Step 212: Drive the display device DISP according to the second image data IMG2.

Step 214: End.

According to the process 20, the embodiment of the present invention may insert the sub-frames Fk_1-Fk_n with adjusted brightness between adjacent frames of the image data IMG1 of the display device DISP, to obtain another image data IMG2 with a higher frame rate. The process 20 performs brightness adjustment on the sub-frames Fk_1-Fk_n by inserting sub-frames with proper brightness combinations, which is different than pure black frame insertion of the prior art, such that both the dynamic effect and the driving power of the display device DISP are considered. In short, the conventional driving method of the display device inserts either full brightness frames or full black frames to increase the frame rate and enhance the dynamic effect of the display device, and thus high power consumption or low brightness may occur. In comparison, the driving process 20 of the present invention reaches a balance among the dynamic display effect, the driving power and the display brightness via inserting the sub-frames (e.g. the plurality of sub-frames Fk_1-Fk_n) with different brightness combinations between adjacent frames (e.g. the first frame Fk and the second frame Fk+1) of the image data IMG1 of the display device DISP.

In detail, the image data IMG1 obtained from step 202 is an image data with lower frame rate and composed of the plurality of frames F1-Fn. In other words, the display device DISP sequentially displays the plurality of frames F1-Fn with the lower frame rate. Then, in step 204, the neighboring first frame Fk and second frame Fk+1 are selected from the plurality of frames F1-Fn. In step 206, the plurality of sub-frames Fk_1-Fk_n to be inserted between two frames (i.e. the first frame Fk and the second frame Fk+1) are calculated according to the first frame Fk and the second frame Fk+1, for increasing the dynamic effect and the frame rate of the image data IMG1. The method of calculating the plurality of sub-frames Fk_1-Fk_n can be derived according to algorithms such as motion interpolation, etc., which should be well known to those skilled in the art, and is not narrated hereinafter. Next, in step 208, the brightness of the plurality of sub-frames Fk_1-Fk_n can be properly adjusted according to different embodiments of the present invention, to reach different brightness arrangements or combinations, so as to comply with different applications. Finally, in step 210, the plurality of sub-frames Fk_1-Fk_n are inserted between the neighboring first frame Fk and second frame Fk+1, to obtain the image data IMG2 which has better dynamic effect and higher frame rate in comparison with the image data IMG1, and in step 212, the image data IMG2 is used to drive the display device DISP.

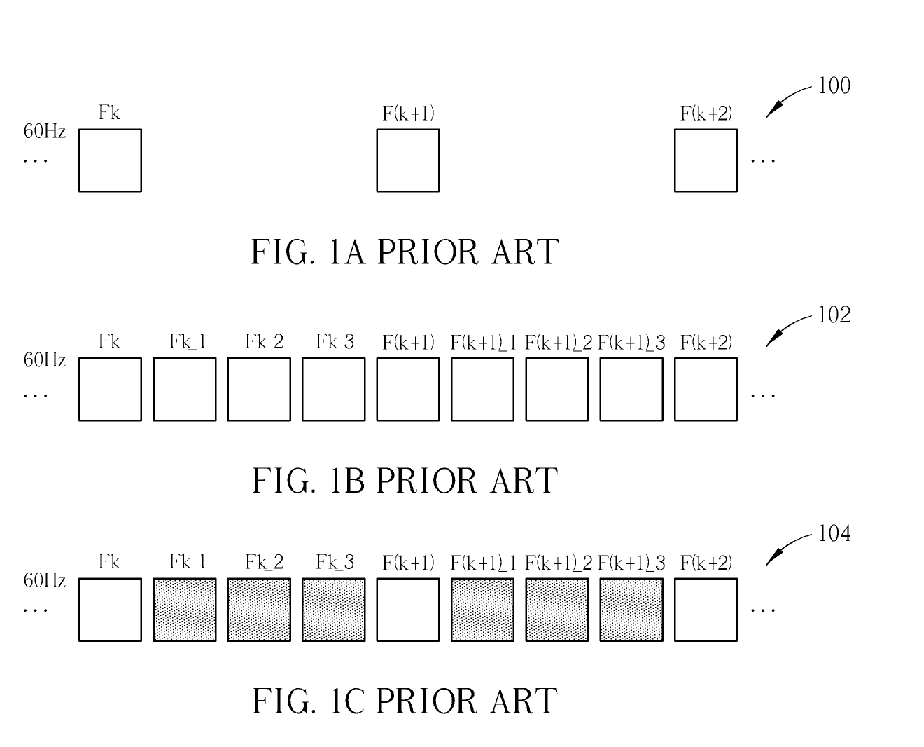

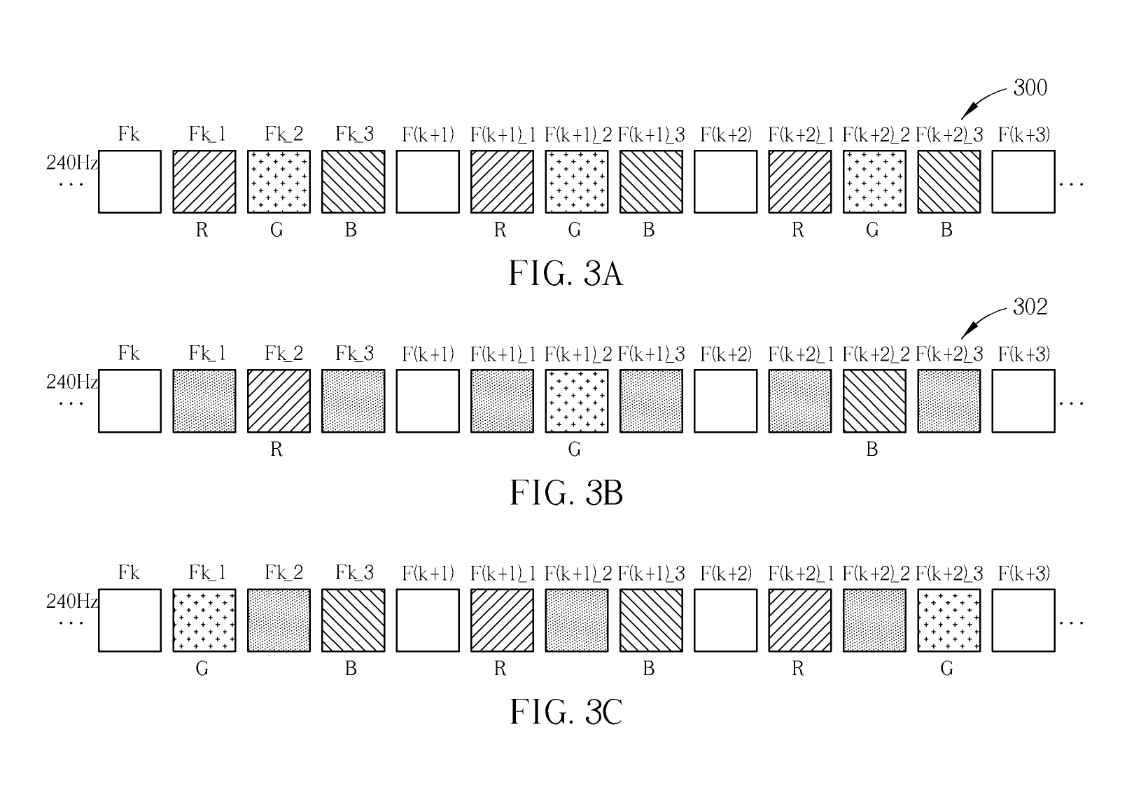

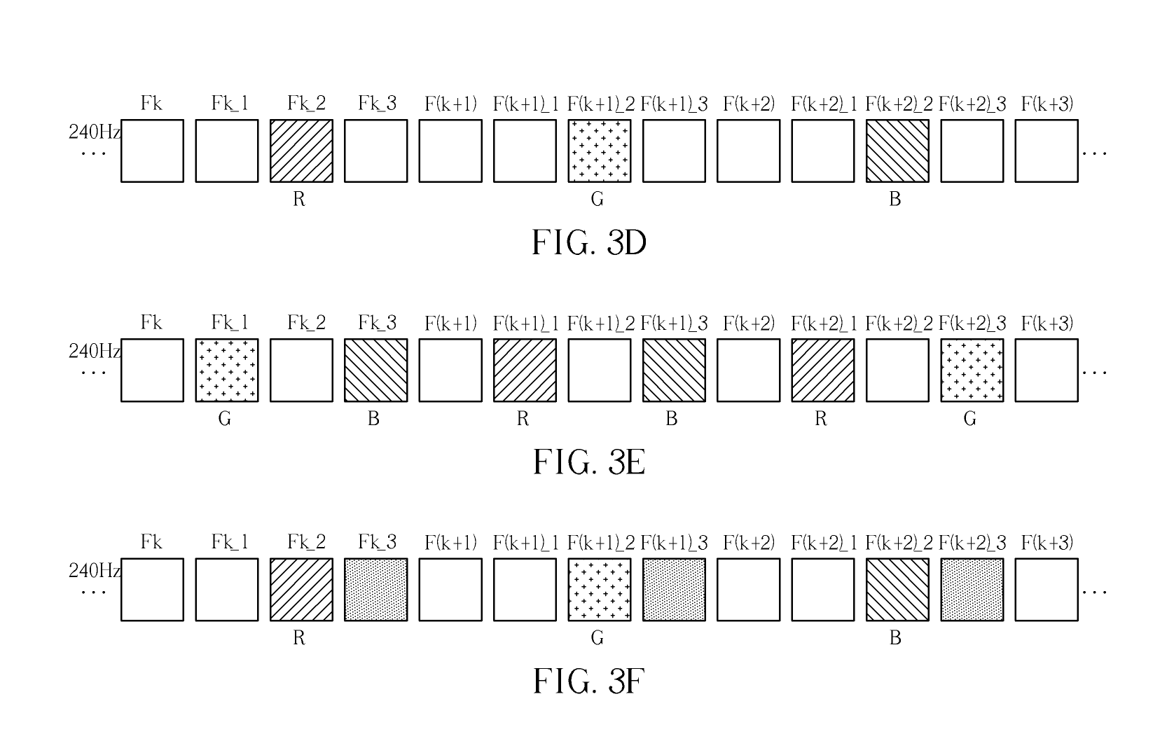

Please refer to FIG. 3A, which is a schematic diagram of processing an image data 300 according to the display driving process 20. The image data 300 is obtained by inserting a plurality of sub-frames into the image data 100 of frame rate 60 Hz shown in FIG. 1A. In this example, n=3, which means three sub-frames are inserted between every adjacent frames in the image data 100, to obtain an image data 300 with a frame rate 240 Hz. As shown in FIG. 3A, Fk, F(k+1), F(k+2) and F(k+3) are four consecutive adjacent frames in the image data 100. According to the display driving process 20, sub-frames Fk_1, Fk_2, Fk_3 are inserted between the frames Fk and F(k+1); sub-frames F(k+1)_1, F(k+1)_2, F(k+1)_3 are inserted between the frames F(k+1) and F(k+2); and sub-frames F(k+2)_1, F(k+2)_2, F(k+2)_3 are inserted between the frames F(k+2) and F(k+3).

In the embodiment, a method of adjusting the sub-frames is changing image compositions of the sub-frames from full-color (i.e. primary colors of R, G, B) to single color (e.g. only red component). In other words, the sub-frames Fk_1, Fk_2, Fk_3 inserted between the frames Fk and F(k+1) are monochrome images of red (R), green (G) and blue (B) sequentially. Similarly, the sub-frames F(k+1)_1, F(k+1)_2, F(k+1)_3, and F(k+2)_1, F(k+2)_2, F(k+2)_3 are respectively monochrome images of R, G and B. Since the frames Fk, F(k+1), F(k+2) and F(k+3) in the image data 100 are full-color images with R, G and B components, monochromatic sub-frames (e.g. the red sub-frame Fk_1) only consume one third driving power of the display device DISP. Therefore, as to requirement of frame rate 240 Hz, the image data 300 reaches dynamic effect as the image data 102 shown in FIG. 1B does, while the image data 300 requires half power the image data 102 requires, i.e. a ratio of the power consumption of the image data 300 and the image data 102 is (1+3×1/3):(1×4)==1:2. Meanwhile, a ratio of display brightness of the image data 104 in FIG. 1C and the image data 300 is (1+3×0):(1+3×1/3)=1:2, i.e. the image data 300 reaches more than twice brightness in comparison to the image data 104 with the inserted black frames.

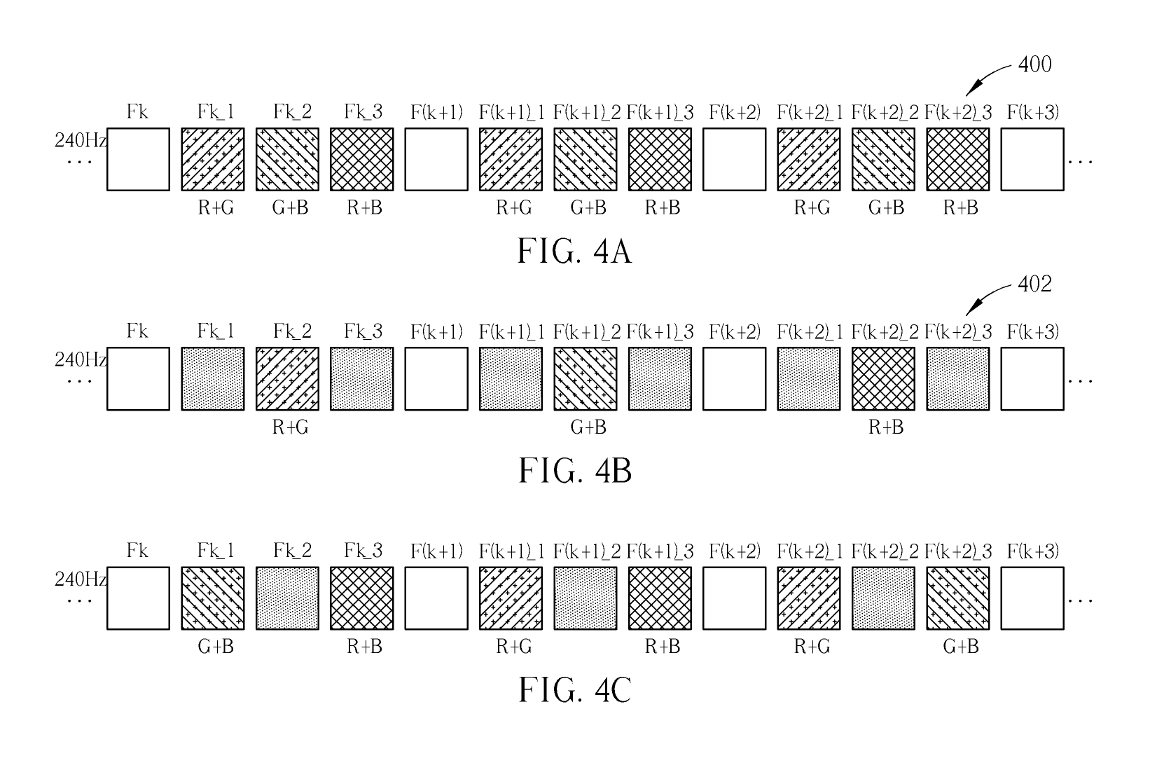

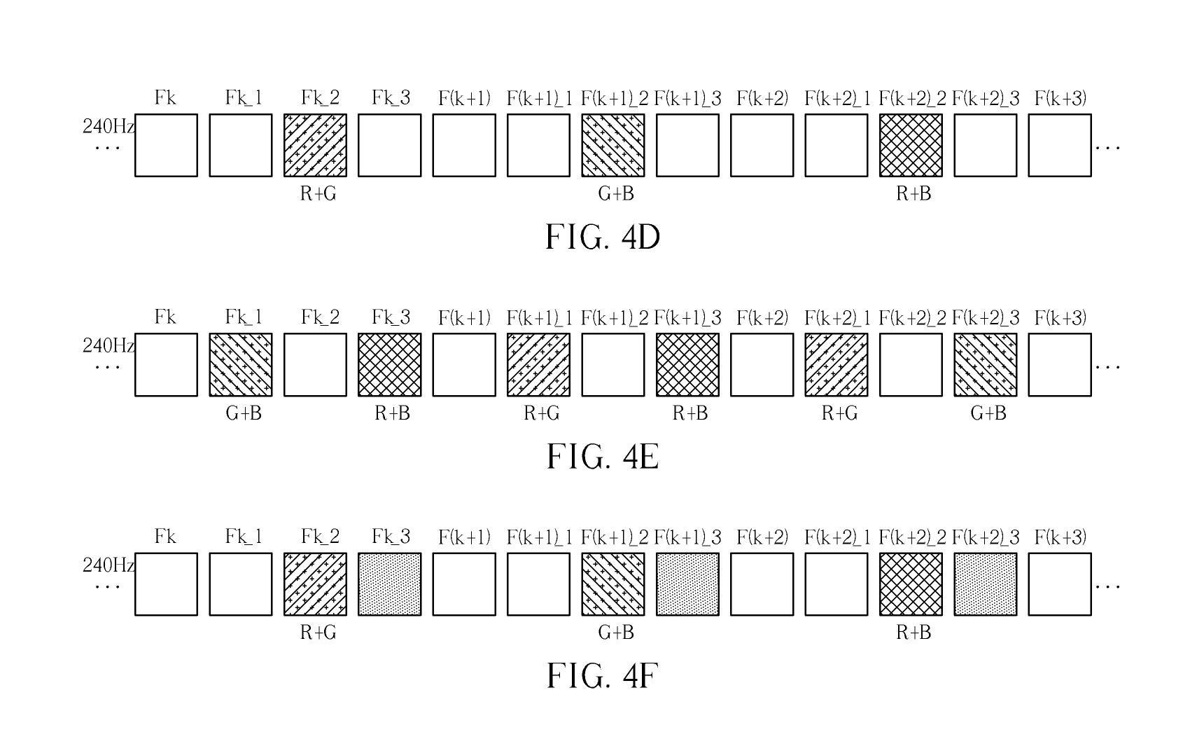

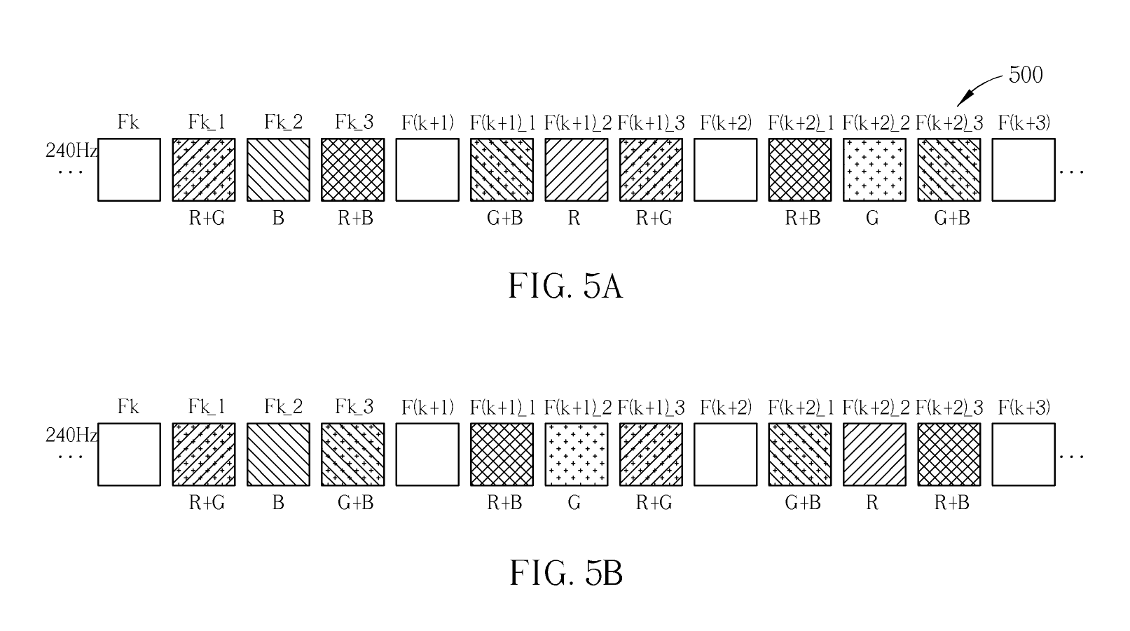

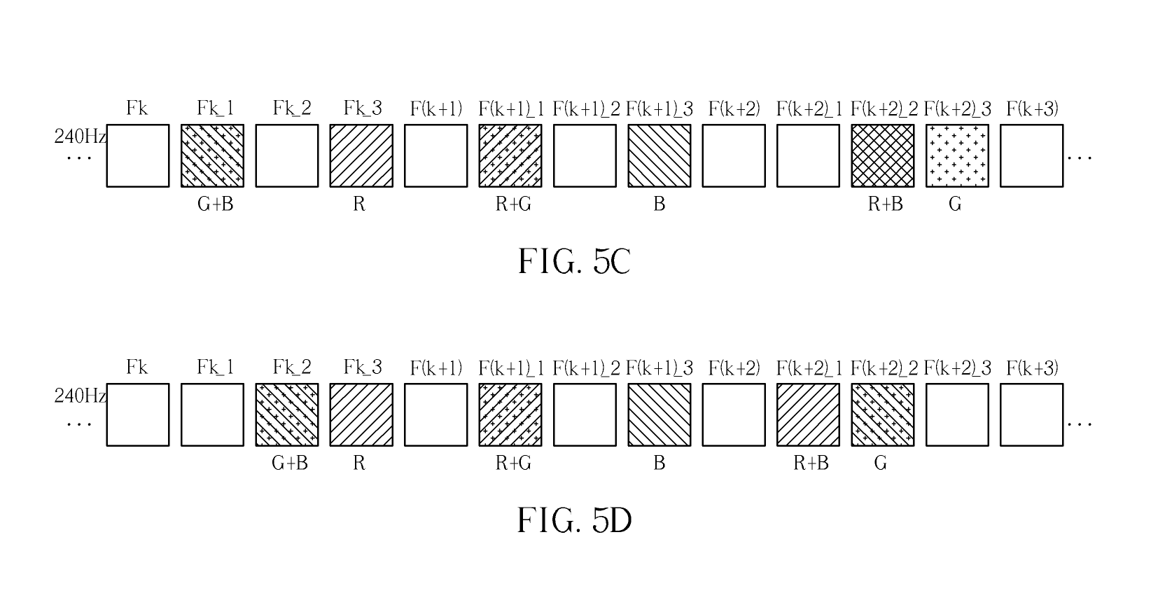

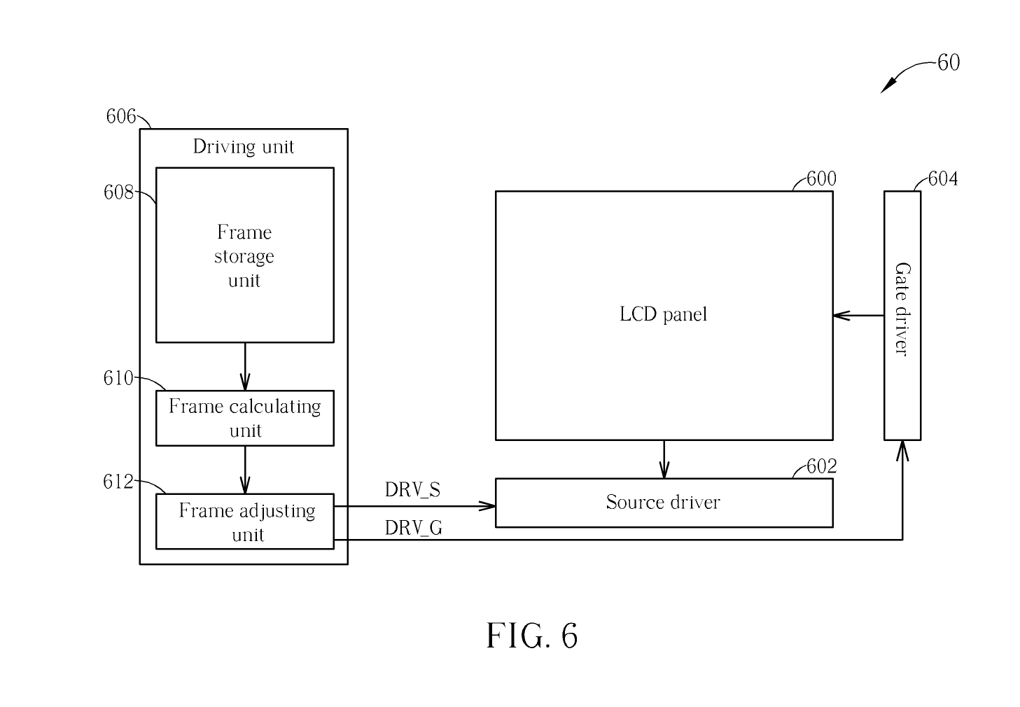

Note that, the driving method of the image data 300 shown in FIG. 3A is an embodiment, and those skilled in the art may properly adjust the driving method of the image data 300, to comply with different requirements. In another embodiment, the brightness of the sub-frames can be adjusted to have arbitrary brightness arrangements or combinations, as long as the dynamic effect and the driving power are taken into account. Furthermore, FIG. 3B-FIG. 3F, FIG. 4A-FIG. 4F, and FIG. 5A-FIG. 5D are schematic diagrams of different embodiments of the present invention. In detail, FIG. 3A-FIG. 3F are image data obtained from different arrangements of monochrome frames, black frames and full-color frames, FIG. 4A-FIG. 4F are image data obtained from different arrangements of two-color frames, black frames and full-color frames, and FIG. 5A-FIG. 5D are image data obtained from different arrangements of monochrome frames, two-color frames, black frames and full-color frames.

In detail, please refer to FIG. 3B, which is a schematic diagram of processing an image data 302 according to the display driving process 20. In the image data 302, a monochrome frame of a primary color and two black frames are inserted between every adjacent frames, and the primary color alternately changes between frames. As shown in FIG. 3B, the sub-frame Fk_2 of the sub-frames Fk_1, Fk_2 and Fk_3 between the frames Fk and F(k+1) is selected as the monochrome frame (e.g. with red component), and the sub-frames Fk_1 and Fk_3 are filled with the black frames. Similarly, the sub-frames F(k+1)_2 and F(k+2)_2 are monochrome frames of green and blue respectively, and the other sub-frames F(k+1)_1, F(k+1)_3, F(k+2)_1 and F(k+2)_3 are filled with the black frames. Therefore, as to image data with frame rate 240, the image data 302 reaches dynamic effect as the image data 102 shown in FIG. 1B does, while the image data 300 requires one third power the image data 102 requires, i.e. a ratio of power consumption of the image data 302 and the image data 102 is reduced to (1+1/3):(1×4)==1:3. Meanwhile, a ratio of display brightness of the image data 104 in FIG. 1C and the image data 302 is (1+3×0):(1+1/3)=3:4, i.e. the image data 300 reaches more than brightness of 1.33 times in comparison to the image data 104 with the inserted black frames. Similarly, the image data of FIG. 3C-FIG. 3F can reach better dynamic effect, in comparison to the image data 100 in FIG. 1A, with less driving power, in comparison to the image data 104 shown in FIG. 1C. In addition, FIG. 3C-FIG. 3F provide different driving methods with different dynamic effects and driving power, to facilitate various applications.

Furthermore, please refer to FIG. 4A, which is a schematic diagram of processing an image data 400 according to the display driving process 20. Three two-color frames (e.g. R+G, G+B, R+B) with three colors alternated are inserted between adjacent frames in the image data 400. Or, as shown in FIG. 4B, the sub-frame Fk_2 of the sub-frames Fk_1, Fk_2 and Fk_3 between the frames Fk and F(k+1) is selected as a two-color frame (e.g. R+G), the other sub-frames Fk_1 and Fk_3 are filled with the black frames, and the sub-frames F(k+1)_2 and F(k+2)_2 are other two-color frames in turn. Similarly, the image data of FIG. 4C-FIG. 4F can reach better dynamic effect, in comparison to the image data 100 in FIG. 1A, with less driving power, in comparison to the image data 104 shown in FIG. 1C. In addition, FIG. 4C-FIG. 4F provide different driving methods with different dynamic effects and driving power, to facilitate various applications.

On the other hand, please refer to FIG. 5A, which is a schematic diagram of processing an image data 500 according to the display driving process 20. Two two-color frames (e.g. R+G, R+B) with the three colors alternated and a monochrome frame (e.g. B) are inserted between adjacent frames of the image data 500, and change colors every frame, i.e. with a frequency of 60 Hz. Similarly, the image data of FIG. 5A-FIG. 5D can reach better dynamic effect, in comparison to the image data 100 in FIG. 1A, with less driving power, in comparison to the image data 104 shown in FIG. 1C. In addition, FIG. 5A-FIG. 5D provide different driving methods with different dynamic effects and driving power, to facilitate various applications.

Realization of the process 20 can be referred to FIG. 6, which is a schematic diagram of a display device 60 according to an embodiment of the present invention. The display device 60 includes an LCD panel 600, a source driver 602, a gate driver 604 and a driving unit 606. The driving unit 606 includes a frame storage unit 608, a frame calculating unit 610 and a frame adjusting unit 612. The driving unit 606 outputs driving signals DRV_S, DRV_G to the gate driver 604 and the driving unit 606 respectively, to drive the LCD panel 600 to display an image data. In detail, the frame storage unit 608 receives and stores n frames F1-Fn (not shown). The frame calculating unit 610 calculates how many sub-frames should be inserted between the adjacent frames of the frames F1-Fn respectively and what kind of brightness combination (e.g. combinations of the monochrome frame, the two-color frame or the black frame) should be presented by each sub-frame according to the different applications. Finally, the frame adjusting unit 612 generates the driving signals DRV_S, DRV_G to the gate driver 604 and the driving unit 606 accordingly, to drive the LCD panel 600 by a specific frame rate to display image data with adjusted brightness, such that the LCD panel 600 can reach excellent dynamic effect, low driving power and normal display brightness. The detailed operations of the display device 60 can be derived by referring to descriptions of the process 20, and are not narrated hereinafter.

Note that, a spirit of the present invention is to insert sub-frames with different brightness combinations into image data. For example, the different driving methods of the present invention can be combined and applied to a display device, and are not limited to be independent. In addition, the display device can also have different display modes. In a high performance mode requiring high brightness, sub-frames with higher proportion of the full color frames or the two-color frames (e.g. the image data 400) can be selected and inserted into the image data. In a power saving mode requiring lower display brightness or low power, sub-frames with higher proportion of the monochrome frames or the black frames (e.g. the image data 302) can be selected and inserted into the image data. In addition, the amount of sub-frames to be inserted can be determined according to the required frame rate; for example, the frame rate 60 Hz of the image data can be increased to 120 Hz by inserting a sub-frame (n=1) into the adjacent frames of the image data. Moreover, in the present invention, the sub-frames have uniform distribution of red, green and blue components, to avoid chromatic aberration, but can be altered to have different distribution (e.g. higher ratio of red frame), to achieve different display effects, such as different color temperatures, etc.

To sum up, the conventional display driving method can only insert full brightness or full black frames to increase the frame rate and enhance the dynamic effect, which causes disadvantages of high power consumption or low brightness. In comparison, the driving method of the present invention inserts the sub-frames with different brightness combinations between adjacent frames, to reach a balance among the dynamic display effect, the driving power and the display brightness.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method for a display device, comprising:
receiving a first image data corresponding to a display of the display device and composed of a plurality of frames;
obtaining a first frame and a second frame neighboring to the first frame from the plurality of frames;
calculating a plurality of sub-frames according to the first frame and the second frame;
adjusting a brightness of at least one sub-frame of the plurality of sub-frames, to have an average brightness of the plurality of sub-frames be lower than an average brightness of the plurality of frames;
sequentially inserting the plurality of sub-frames between the first frame and the second frame, to obtain a second image data; and
driving the display device according to the second image data.

2. The driving method of claim 1, wherein the step of adjusting the brightness of the at least one sub-frame of the plurality of sub-frames, to have the average brightness of the plurality of sub-frames be lower than the average brightness of the plurality of frames, comprises:
removing at least one component color of the at least one sub-frame respectively.

3. The driving method of claim 1, wherein the step of adjusting the brightness of the at least one sub-frame of the plurality of sub-frames, to have the average brightness of the plurality of sub-frames be lower than the average brightness of the plurality of frames, comprises:
replacing the at least one sub-frame with at least one black frame.

4. The driving method of claim 1, wherein component colors of each frame of the second image data are uniformly distributed.

5. The driving method of claim 1, wherein the plurality of frames are composed of red, blue and green colors, respectively.

6. A driving device for a display device, comprising:
a receiving unit, for receiving a first image data corresponding to a display of the display device and composed of a plurality of frames;
a calculating unit, for obtaining a first frame and a second frame neighboring to the first frame from the plurality of frames, and calculating a plurality of sub-frames according to the first frame and the second frame;
an adjusting unit, for adjusting a brightness of at least one sub-frame of the plurality of sub-frames, to have an average brightness of the plurality of sub-frames be lower than an average brightness of the plurality of frames, and sequentially inserting the plurality of sub-frames between the first frame and the second frame, to obtain a second image data; and
a driving unit, for driving the display device according to the second image data.

7. The driving device of claim 6, wherein the adjusting unit removes at least one component color of the at least one sub-frame respectively, to adjust the brightness of the at least one sub-frame of the plurality of sub-frames.

8. The driving device of claim 6, wherein the adjusting unit replaces the at least one sub-frame with at least one black frame, to adjust the brightness of the at least one sub-frame of the plurality of sub-frames.

9. The driving device of claim 6, wherein component colors of each frame of the second image data are uniformly distributed.

10. The driving device of claim 6, wherein the plurality of frames are composed of red, blue and green colors, respectively.
